(19) United States
(12) Patent Application Publication
(10) Pub. No.: US 2015/0029340 A1
(43) Pub. Date: Jan. 29, 2015

(54) WATER DROPLET REMOVAL APPARATUS AND CAMERA APPARATUS

(71) Applicant: JVC KENWOOD Corporation, Yokohama-shi (JP)

(72) Inventors: Hiromi TAGUCHI, Sagamihara-shi (JP); Makoto FUKASAWA, Tokyo (JP)

(21) Appl. No.: 14/312,160

(22) Filed: Jun. 23, 2014

(30) Foreign Application Priority Data
Jul. 26, 2013 (JP) 2013-155286
Jul. 26, 2013 (JP) 2013-155288
Oct. 31, 2013 (JP) 2013-226389

(51) Int. Cl. H04N 7/18; B08B 3/02

(52) U.S. Cl. CPC H04N 7/183; B08B 3/02
USPC 348/151

(57) ABSTRACT

A jetting nozzle is configured to jet a shock wave onto an imaging window of a camera. An arrangement section arranges the jetting nozzle on a periphery of the imaging window. The shock wave generation unit is configured to generate the shock wave jetted from the jetting nozzle. The jetting control unit is configured to control jetting of the shock wave jetted from the jetting nozzle.

### CROSS REFERENCE TO RELATED APPLICATION

This application is based upon and claims the benefit of priority under 35 U.S.C. §119 from Japanese Patent Applications No. 2013-155286, filed on Jul. 26, 2013, No. 2013-155288, filed on Jul. 26, 2013, and No. 2013-226389, filed on Oct. 31, 2013, the entire contents of all of which are incorporated herein by reference.

### BACKGROUND

The present disclosure relates to a water droplet removal apparatus, which removes a water droplet adhered to an imaging window provided on a housing that stores a camera therein, and to a camera apparatus equipped with a water droplet removal function.

Heretofore, for this type of technology, one described in Japanese Patent Laid-Open Publication No. H06-303471 (Patent Literature 1, published in 1994) is known.

Patent Literature 1 describes a technology of a surveillance camera apparatus that images a subject through a flat imaging window provided on a box-like housing that stores a surveillance camera therein. On the imaging window, a wiper that cleans a surface of the imaging window is provided.

Moreover, as the surveillance camera apparatus, a dome-like surveillance camera apparatus that images the subject through an approximately hemispherical dome cover has been known. The dome cover of the imaging window is formed into an approximately hemispherical shape, and accordingly, it has been difficult to clean a surface of the imaging window by the wiper as mentioned above, which cleans a flat surface.

In the dome-like surveillance camera apparatus, hydrophilic or water-repellent coating has been implemented on a surface of the dome cover, a bad influence given to a captured image by a water droplet such as a rain droplet has been suppressed, and sharpening of the image has been achieved.

### SUMMARY

In the above-described conventional dome-like surveillance camera apparatus, when the subject has been magnified and imaged in a state where the water droplet has been adhered to the dome cover subjected to the hydrophilic coating, it has become difficult to focus the subject, and there is a possibility that the captured image may become unclear.

In a case where the subject has been imaged at a wide angle in a state where a water droplet has adhered to the dome cover subjected to the water-repellent coating, and the water droplet has been focused on, then there is a possibility that the captured image may become unclear.

When the water droplet adhered to the dome cover has been dried in the case where the dome cover has been subjected to the hydrophilic or water-repellent coating, dirt is prone to remain on the surface of the dome cover. Therefore, there is a possibility that the captured image may become unclear.

It is an object of the embodiments to provide a water droplet removal apparatus capable of achieving sharpening of the captured image acquired in such a manner that the camera images the subject through the imaging window, and to provide a camera apparatus equipped with a water droplet removal function.

A first aspect of the embodiments provides a water droplet removal apparatus comprising: a jetting nozzle configured to jet a shock wave onto an imaging window of a camera; an arrangement section that arranges the jetting nozzle on a periphery of the imaging window; a shock wave generation unit configured to generate the shock wave jetted from the jetting nozzle; and a jetting control unit configured to control jetting of the shock wave jetted from the jetting nozzle.

A second aspect of the embodiments provides a camera apparatus comprising: an imaging window; a camera configured to image a subject through the imaging window; a jetting nozzle arranged at a position from which a shock wave is jetted toward a portion where a water droplet adhered to the imaging window is built up, the jetting nozzle being configured to jet the shock wave onto the imaging window; a shock wave generation unit configured to generate the shock wave jetted from the jetting nozzle; and a jetting control unit configured to control the jetting of the shock wave jetted from the jetting nozzle.

### BRIEF DESCRIPTION OF THE DRAWINGS

FIG. 1 is a perspective view showing an exterior appearance of a surveillance camera apparatus to which a water droplet removal apparatus according to Embodiment 1 is attached.

FIG. 2 is a perspective view showing an exterior appearance of the water droplet removal apparatus according to Embodiment 1.

FIG. 3 is a perspective view showing an exterior appearance of the surveillance camera apparatus to which the water droplet removal apparatus is not attached.

FIG. 4 is a perspective view showing exterior appearances of jetting nozzles and a dome cover.

FIG. 5 is a partial plan view showing a vertical positional relationship between the jetting nozzles and the dome cover.

FIG. 6 is a plan view showing a horizontal positional relationship between the jetting nozzles and the dome cover.

FIG. 7 is a perspective view showing an exterior appearance of each of the jetting nozzles attached to a gush bracket.

FIG. 8 is a perspective view showing an internal configuration of a storage section.

FIG. 9 is a perspective view showing an exterior appearance of fixed nozzle jetting ports in a fixed nozzle.

FIG. 10 is a perspective view showing an exterior appearance of a principal section of the water droplet removal apparatus according to Embodiment 1.

FIG. 11 is a perspective view showing an exterior appearance of a selection section viewed from a sliding nozzle side.

FIG. 12 is a perspective view showing the selection section when viewed from a fixed nozzle side.

FIG. 13 is a perspective view showing the exterior appearance of the selection section when viewed from the sliding nozzle side.

FIG. 14 is a perspective view showing an attaching structure for a shock wave generation unit.

FIG. 15 is a perspective view showing the attaching structure for the shock wave generation unit.

FIG. 16 is a perspective view showing an attaching structure for a switching power supply unit.

FIG. 17 is a diagram showing a configuration for controlling the camera and the water droplet removal apparatus.

FIG. 18 is a view showing an arrangement example of the jetting nozzles.

FIG. 19 is a perspective view showing an exterior appearance of a surveillance camera apparatus to which a water droplet removal apparatus according to Embodiment 2 is attached.

FIG. 20 is a view showing an arrangement example of a jetting nozzle.

FIG. 21 is a view showing an arrangement example of the jetting nozzle.

FIG. 22 is a perspective view showing an exterior appearance of a principal section of the water droplet removal apparatus according to Embodiment 2.

### DETAILED DESCRIPTION

A description is made below of embodiments by using the drawings.

### Embodiment 1

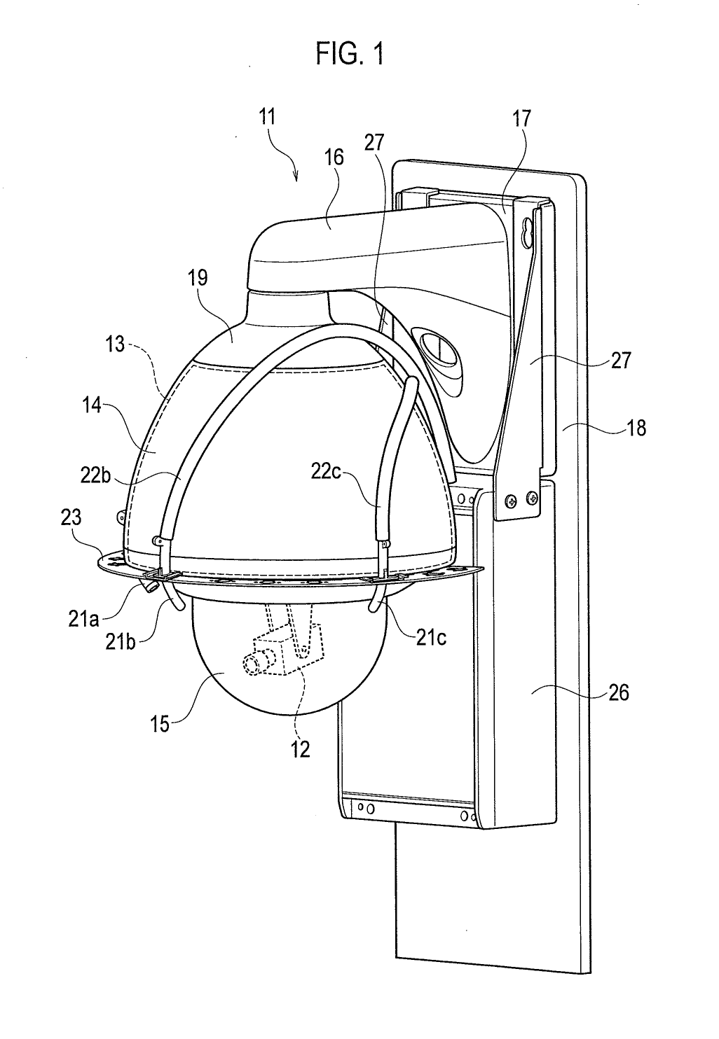

FIG. 1 is a perspective view showing an exterior appearance of a surveillance camera apparatus including a water droplet removal apparatus according to Embodiment 1.

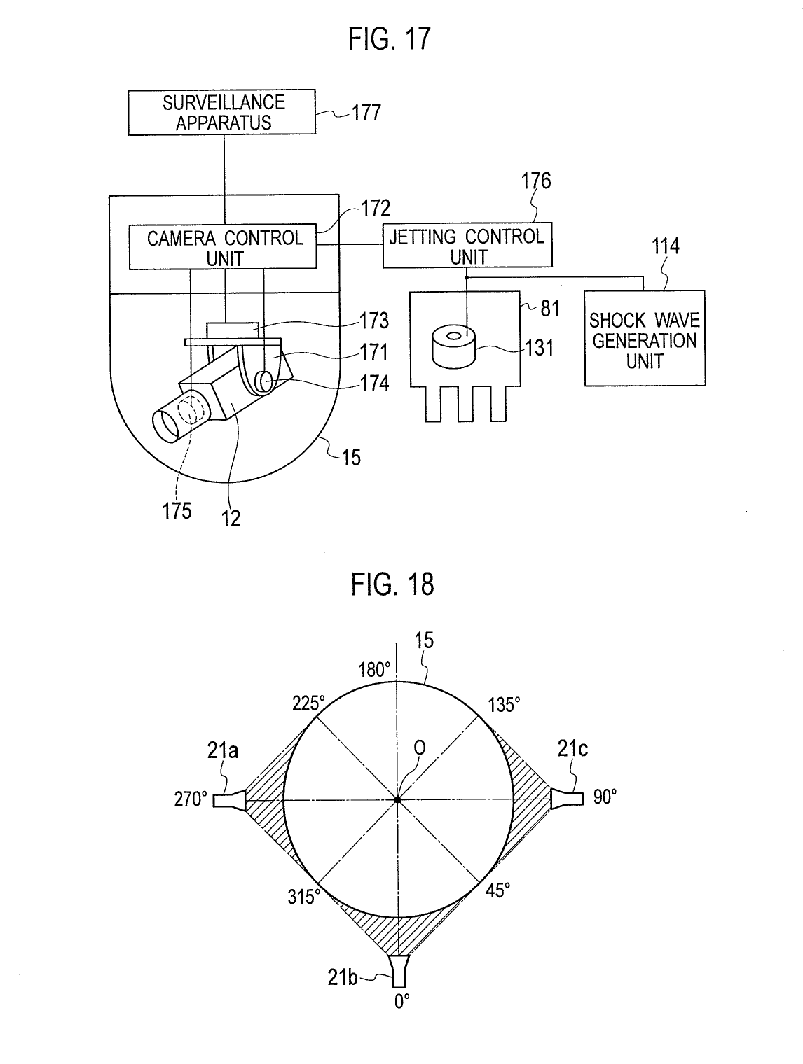

In FIG. 1, a surveillance camera apparatus 11 includes a camera 12 that images a subject as a surveillance target. The camera 12 is supported by being suspended by a support drive unit 171 (shown in FIG. 17), which is provided in a temple bell-like cabinet section 13 and will be described later, and is rotatably housed in the cabinet section 13. Onto an outer circumferential surface of the cabinet section 13, a sun shade cover 14 for shading the sun is attached.

On a lower portion of the cabinet section 13, a hemispherical dome cover 15, which is transparent or translucent, is provided. The camera 12 images the subject through the dome cover 15 serving as an imaging window, and acquires an image of the subject.

On an upper portion of the cabinet section 13, an arm 16 that supports the cabinet section 13 is provided and a pedestal section 17 integrated with this arm 16 is fixed to a wall 18 by fixtures such as screws. In such a way, the cabinet section 13 is attached to the wall 18.

The water droplet removal apparatus is attached to the surveillance camera apparatus 11, and removes or micronizes a water droplet, which is adhered to the dome cover 15, by a shock wave, and thereby improves quality of the image acquired by the camera 12. The shock wave is an aerial vibration wave, and propagates in the air at a speed close to the sonic speed.

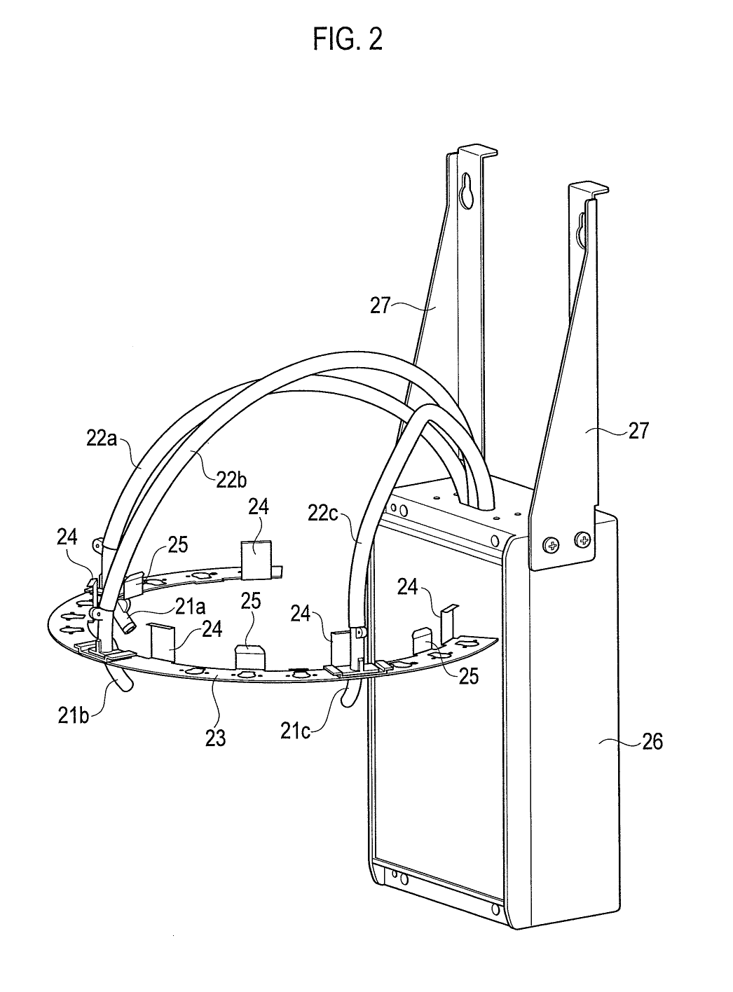

In FIG. 2, the water droplet removal apparatus includes: three jetting nozzles 21 (21a, 21b, 21c): and three shock wave guide tubes 22 (22a, 22b, 22c). Note that the number of the jetting nozzles 21 and the number of the shock wave guide tubes 22 are not limited to the number described above.

Each of the jetting nozzles 21 jets the shock wave to a surface of the dome cover 15. The jetting nozzle 21 jets the shock wave from a jetting port on one end thereof, and the shock wave guide 22 fitted into the other end thereof, and the other end is joined to the shock wave guide tube 22.

That is to say, the jetting nozzle 21a is joined to the shock wave guide tube 22a, the jetting nozzle 21b is joined to the shock wave guide tube 22b, and the jetting nozzle 21c is joined to the shock wave guide tube 22c. Note that a junction of each of the jetting nozzles 21 and each of the shock wave guide tubes 22 is clamped by a band or the like, whereby an effect of preventing separation therebetween can be enhanced.

The jetting nozzles 21 are attached to a gush bracket 23, which composes an arrangement section that arranges the jetting nozzles 21 on a periphery of the dome cover 15.

On the gush bracket 23, a plurality of engaging claws 24, in which tip end portions are bent outward, are provided. On the gush bracket 23, a plurality of engaging claws 25, in which tip end portions are bent inward, are provided. These engaging claws 24 and 25 are used in an event of attaching the gush bracket 23 to the sun shade cover 14.

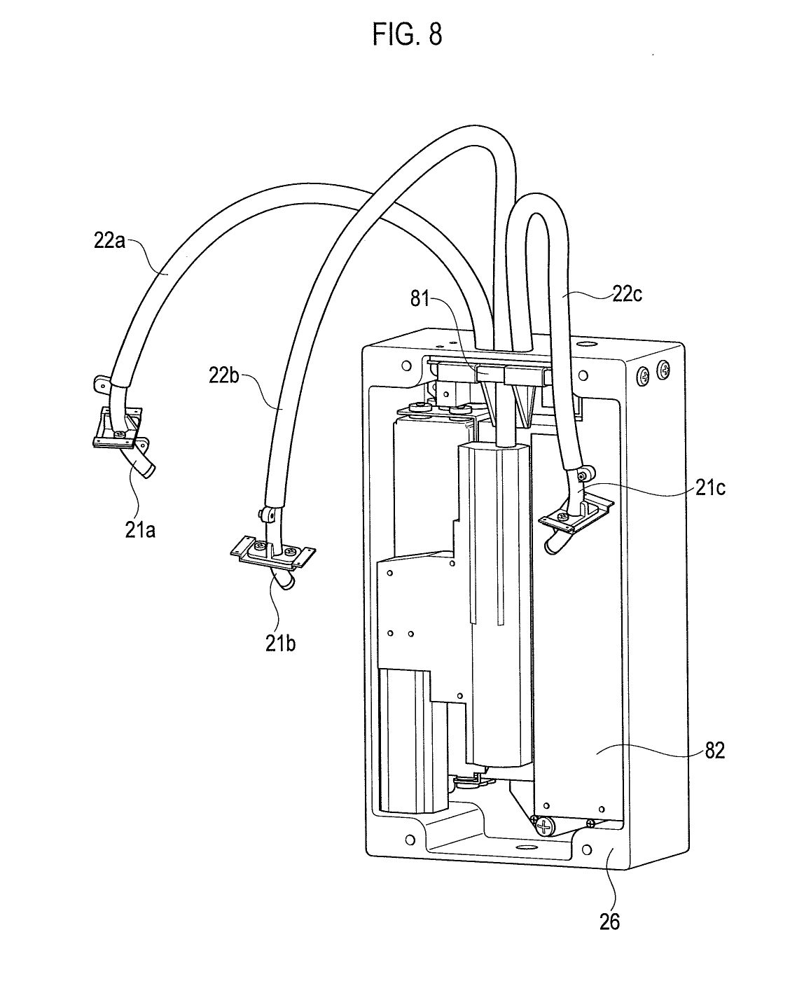

Other ends of the shock wave guide tubes 22 are stored in a storage section 26, and are joined to a selection section 81 (shown in FIG. 8) to be described later. The storage section 26 is composed, for example, of waterproof aluminum die cast, and a right-and-left pair of suspended brackets 27 serving as support members is attached to the storage section 26.

The water droplet removal apparatus is freely detachably attached to the surveillance camera apparatus 11, and accordingly, can be attached thereto later according to needs. A description is made of a method for attaching the water droplet removal apparatus to the surveillance camera apparatus 11 later.

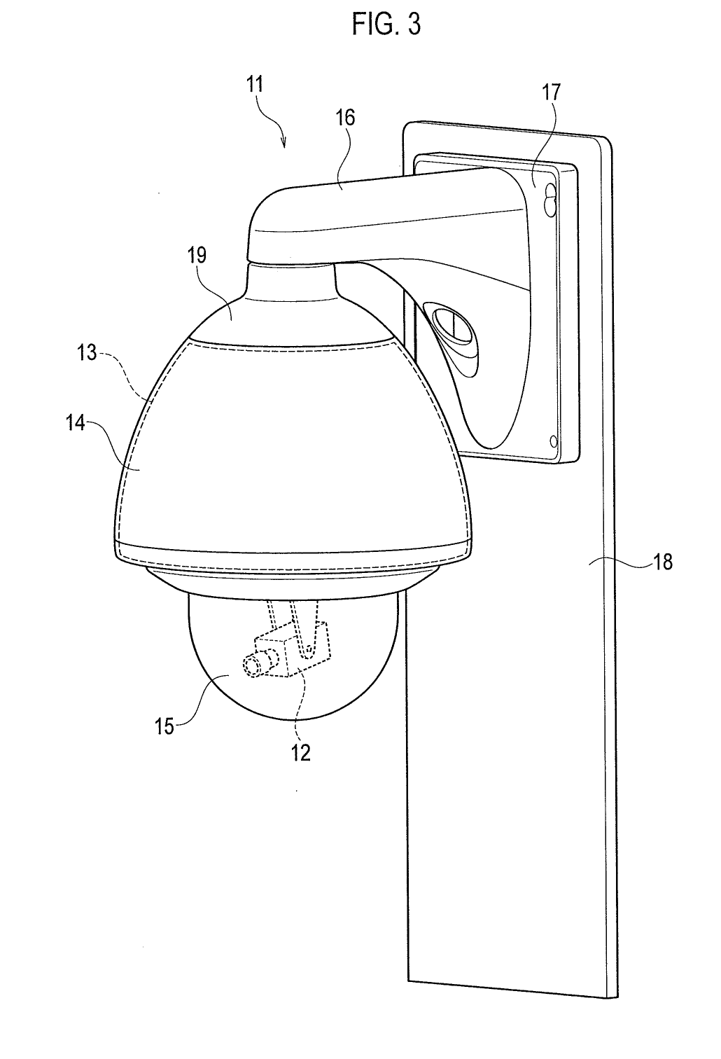

FIG. 3 is a perspective view showing an exterior appearance of the surveillance camera apparatus 11 in a state where the water droplet removal apparatus is not attached to the surveillance camera apparatus 11.

In the surveillance camera apparatus 11 shown in FIG. 3, a cover 19 provided on the upper portion of the cabinet section 13 is detached, and the sun shade cover 14 is lifted up and moved to an arm 16 side above the cabinet section. 13.

In such a state, the gush bracket 23 attached with the jetting nozzles 21 shown in FIG. 2 is temporarily arranged along a lower outer circumference of the cabinet section 13. Thereafter, the sun shade cover 14 is returned downward, and the engaging claws 24 of the gush bracket 23 are engaged with a groove (not shown) of an engaged portion formed in an inside of the sun shade cover 14. Moreover, the engaging claws 25 of the gush bracket 23 are allowed to abut against a bottom outer circumferential surface of the cabinet section 13. In such a way, the gush bracket 23 is attached to a bottom portion of the sun shade cover 14.

The sun shade cover 14 attached with the gush bracket 23 is fixed to the cabinet section 13 by fixtures such as screws. In such a way, as shown in FIG. 1, the jetting nozzles 21 of the gush bracket 23 attached to the sun shade cover 14 are arranged on the periphery of the dome cover 15.

The storage section 26 is fixed to the wall 18 by the right-and-left pair of suspended brackets 27 together with the pedestal section 17 by fixtures such as screws. Moreover, it is possible to reinforce the storage section 26 by fixing a lower portion of the storage section 26 to the wall 18 by a fixture such as a screw.

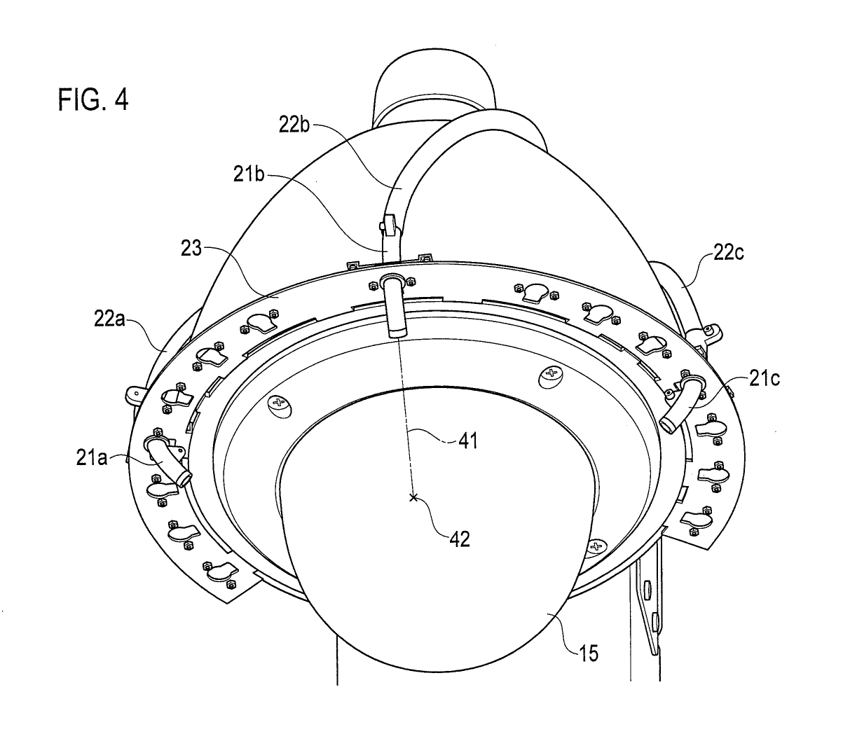

FIG. 4 is a perspective view showing an exterior appearance of such a periphery of the dome cover 15 and the jetting nozzles 21.

The jetting ports on such tip end portions of the jetting nozzles 21 attached to the gush bracket 23 are directed toward the dome cover, and the shock waves jetted from the jetting ports hit the surface of the dome cover 15.

The water droplet such as a rain droplet adhered to the surface of the dome cover 15 is removed by being blown away by the energy of each of the shock waves. Alternatively, the water droplet is micronized by being broken by the energy of the shock wave.

For example, when the jetting nozzle 21b shown in FIG. 4 is taken as a representative, the water droplet is blown away radially and outward from an intersection 42 of a centerline 41 of a jetting direction of the shock wave and the dome cover 15, the intersection 42 being taken as a center, in an approximately concentric manner therewith, or the water droplet moves on the surface of the dome cover 15. Alternatively, a part of the water droplet is micronized without being blown away, and remains on the surface of the dome cover 15.

The jetting of the shock waves from the three jetting nozzles 21a, 21b and 21c is controlled as mentioned later, whereby the water droplet is removed from the dome cover 15 within an imaging range of the camera 12, or is micronized. As a result, in comparison with a case before the water droplet is removed or micronized, the camera 12 can acquire a clearer and better image of the subject.

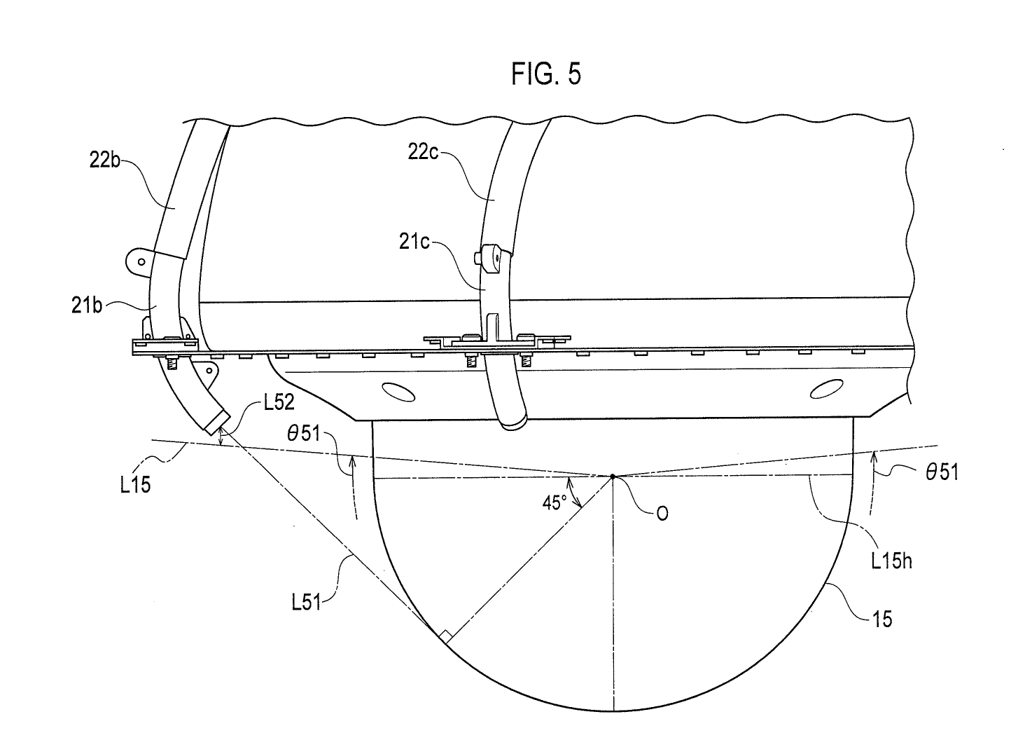

A direction of each of the jetting ports of the jetting nozzles 21 is set, for example, as shown in FIG. 5. In FIG. 5, an alternate long and short dashed line L15h indicates a position where a hemisphere is just formed in the dome cover 15.

That is to say, an end surface of the hemisphere is located along a position of the alternate long and short dashed line L15h. As shown in FIG. 5, such an orientation of the jetting port is set so as to coincide with a direction of a tangential line L51 with respect to a position at approximately 45° from a center O of the end surface of the hemisphere.

As shown in FIG. 5, in terms of the position, each of the jetting ports of the jetting nozzles 21 are arranged with respect to an angle of view θ51, which serves as an imaging range in a tilt direction of the camera 12, so as to go out of a range of this angle of view θ51. Moreover, in terms of the position, each of the jetting ports of the jetting nozzles 21 is arranged so that a distance L52 from an uppermost end L15 of the imaging range with respect to the angle of view θ51, which serves as the imaging range in the tilt direction of the camera 12, can become as short as possible.

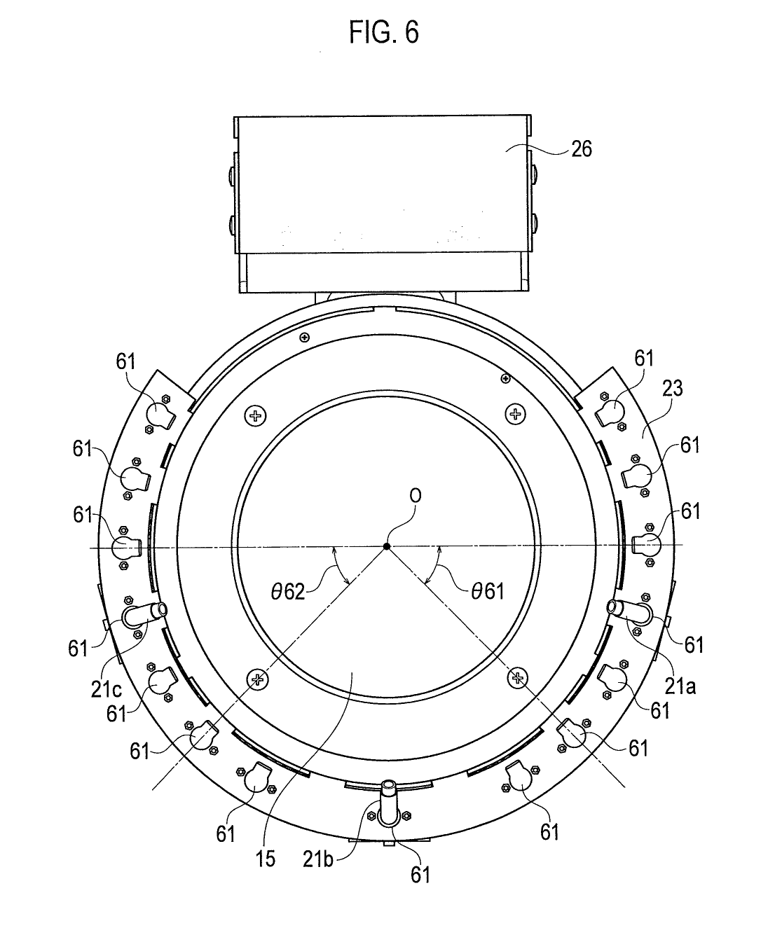

FIG. 6 is a plan view showing an exterior appearance of the dome cover 15 when viewed from a bottom thereof. As shown in FIG. 6, the jetting nozzles 21 are attached to the gush bracket 23, and are arranged on an outer circumference of the dome cover 15.

The jetting nozzle 21b is arranged, for example, in a frontal direction with respect to the center O of the dome cover 15. The jetting nozzle 21a is arranged, for example, in an angular range of θ61 with respect to the frontal direction where the jetting nozzle 21b is arranged. The angular range θ61 becomes a range of +45° to +90° if the frontal direction is 0°.

The jetting nozzle 21c is arranged, for example, in an angular range of 062 with respect to the frontal direction where the jetting nozzle 21b is arranged. The angular range 062 becomes a range of −45° (+315°) to −90° (+270°) if the frontal direction is 0°.

The positions at which the jetting nozzles 21 are arranged are not limited to those described above, and are appropriately set in response to the imaging range of the camera 12. In the gush bracket 23, attachment holes 61, though which the jetting nozzles 21 are inserted and attached, are provided at an angle of approximately 15° with respect to the center O of the dome cover 15.

With regard to the respective jetting nozzles 21a, 21b and 21c, it becomes possible to appropriately change such arrangement positions thereof by changing the attachment holes 61.

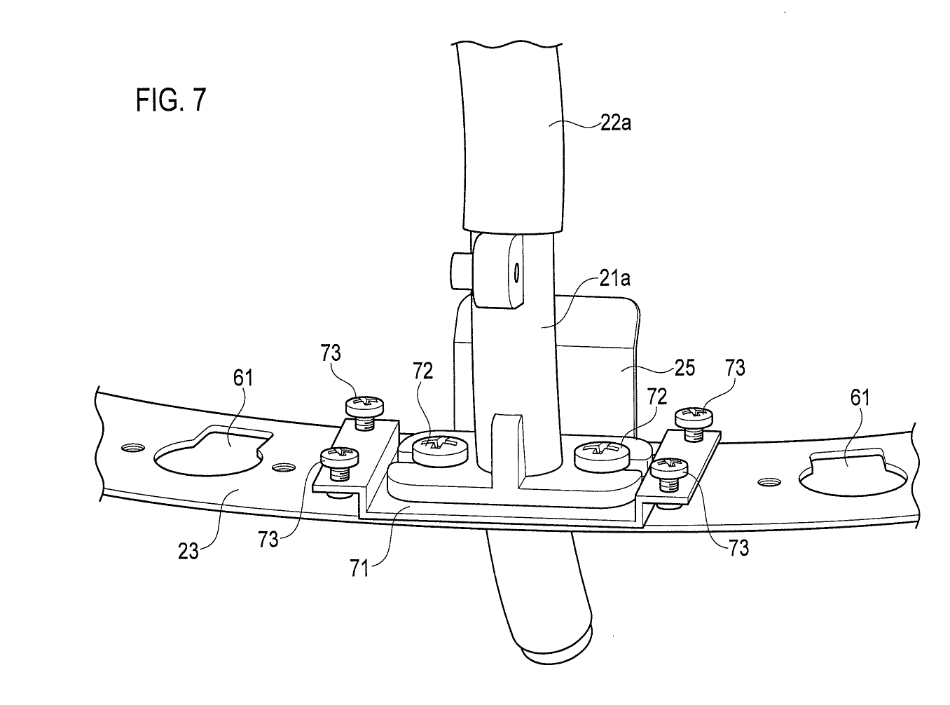

As shown in FIG. 7, each of the jetting nozzles 21 is attached to the gush bracket 23, and the orientation of the jetting port thereof is adjusted.

In FIG. 7, each of the jetting nozzles 21 is fixed by screws 72 to the gush bracket 23 while interposing a support bracket 71 therebetween. In the support bracket 71, adjusting screws 73 are provided on four corners thereof.

In a state where the screws 72 are loosened, a clamping degree of each of the adjusting screws 73 is adjusted, whereby an attaching angle of the support bracket 71 with respect to the gush bracket 23 is changed. In such a way, it becomes possible to finely adjust the orientation of each of the jetting nozzles 21 with respect to the dome cover 15.

As shown in FIG. 8, other ends of the shock wave guide tubes 22 in which one of the ends are joined to the jetting nozzles 21 are stored in the storage section 26, and are joined to the selection section 81 that selects the shock wave guide tube 22 that transmits the shock wave to any one of the jetting nozzles 21a, 21b and 21c. In the storage section 26, a circuit board 82 is stored, on which electronic circuit components such as a jetting control unit to be described later are housed.

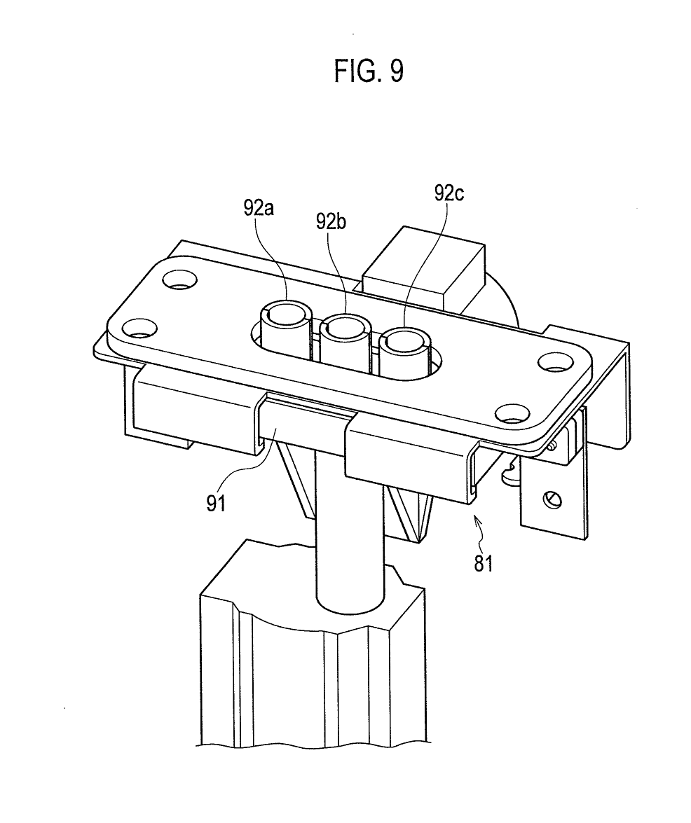

As shown in FIG. 9, the selection section 81 includes a fixed nozzle 91, and three fixed nozzle jetting ports 92 (92a, 92b, 92c) are provided in the fixed nozzle 91. The fixed nozzle jetting ports 92 are provided by being extended in a direction of transmitting the shock waves.

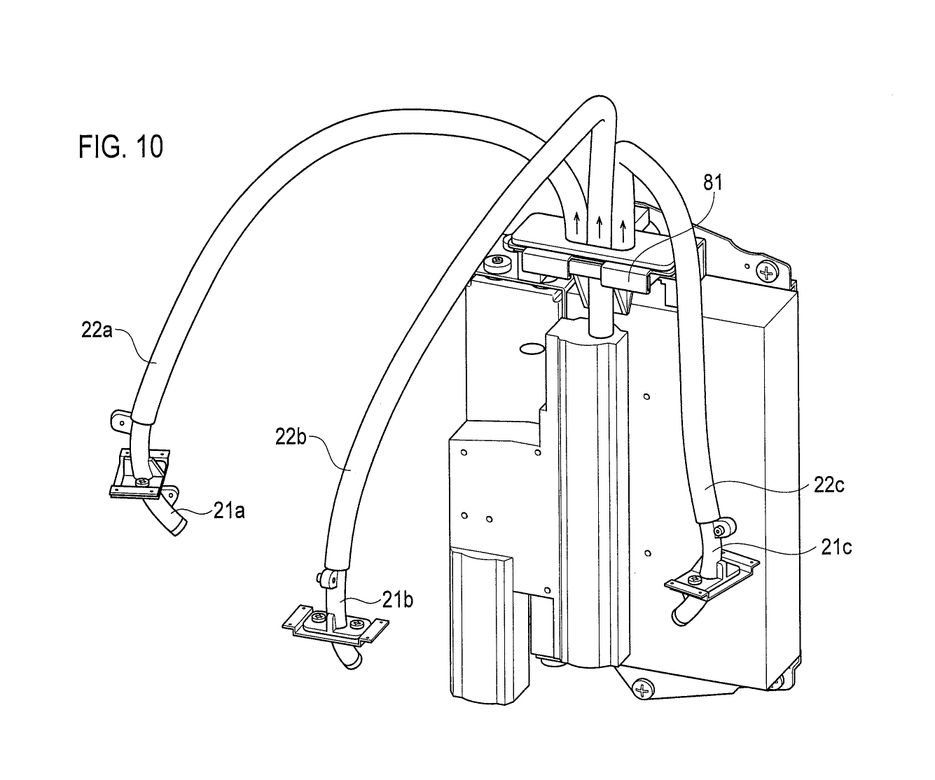

The shock wave guide tubes 22 are fitted into one of the ends of the fixed nozzle jetting ports 92, and are joined thereto so as to go along such a transmission direction of the shock waves, which is shown by arrows of FIG. 10.

That is to say, the shock wave guide tube 22a is joined to the fixed nozzle jetting port 92a, the shock wave guide tube 22b is joined to the fixed nozzle jetting port 92b, and shock wave guide tube 22c is joined to the fixed nozzle jetting port 92c.

The shock wave guide tubes 22 are joined to the fixed nozzle jetting ports 92 so as to go along the transmission direction of the shock waves, and accordingly, attenuation of the shock waves, which is caused by bending of transmission passages in junctions of the shock wave guide tubes 22 and the fixed nozzle jetting ports 92, can be suppressed. Note that the junctions are clamped by bands or the like, whereby an effect of preventing separation between the shock wave guide tubes 22 and the fixed nozzle jetting ports 92 can be enhanced.

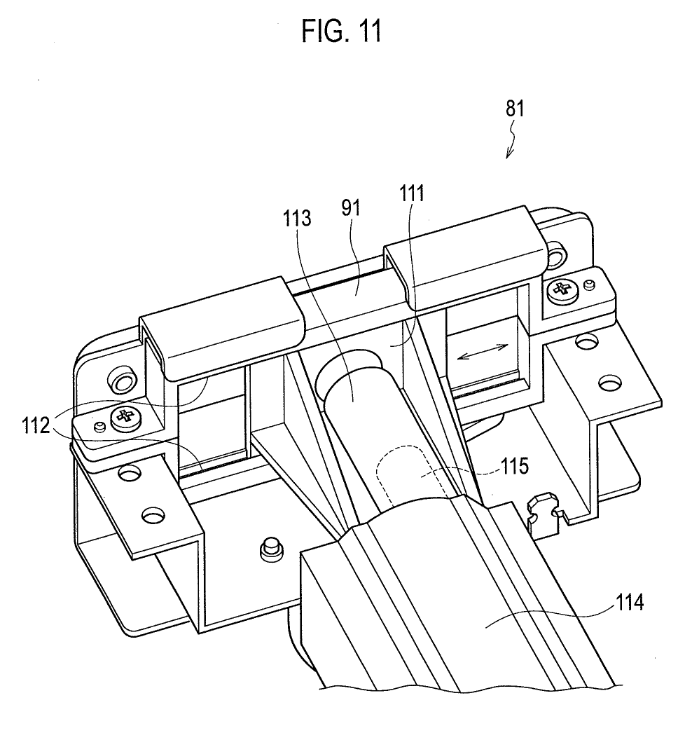

As shown in FIG. 11, the selection section 81 includes a sliding nozzle 111. The sliding nozzle 111 is fitted into a groove-like guide portion 112 provided on the fixed nozzle 91, and is provided so as to be freely movable along the guide portion 112 in a direction shown by an arrow of FIG. 11.

Onto the sliding nozzle 111, one end of a shock wave guide tube 113 is fitted and joined, and the other end of the shock wave guide tube 113 is fitted and joined to a shock wave jetting port 115 of a shock wave generation unit 114. In such a way, the sliding nozzle 111 and the shock wave generation unit 114 are joined to each other while interposing the shock wave guide tube 113 therebetween.

The shock wave guide tube 113 is composed, for example, of a flexible member such as silicone rubber, and is bent following movement of the sliding nozzle 111.

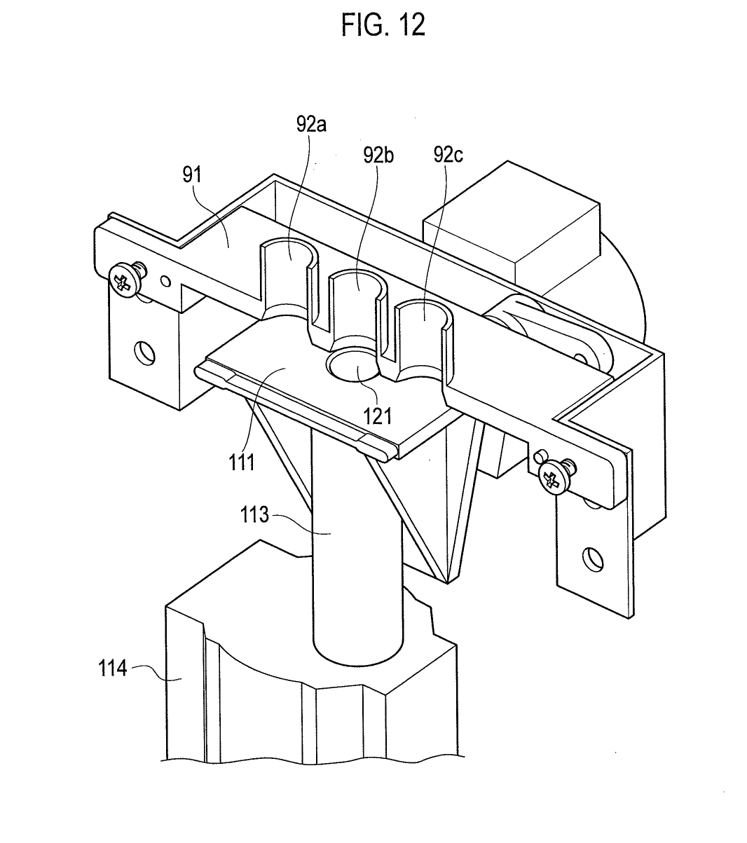

As shown in FIG. 12, the shock wave jetting port 121 of the sliding nozzle 111 and the fixed nozzle jetting ports 92 are composed so as to have approximately the same diameter. The sliding nozzle 111 is moved so that center axes of both of the shock wave jetting port 121 of the sliding nozzle 111 and the fixed nozzle jetting port 92 can approximately coincide with each other.

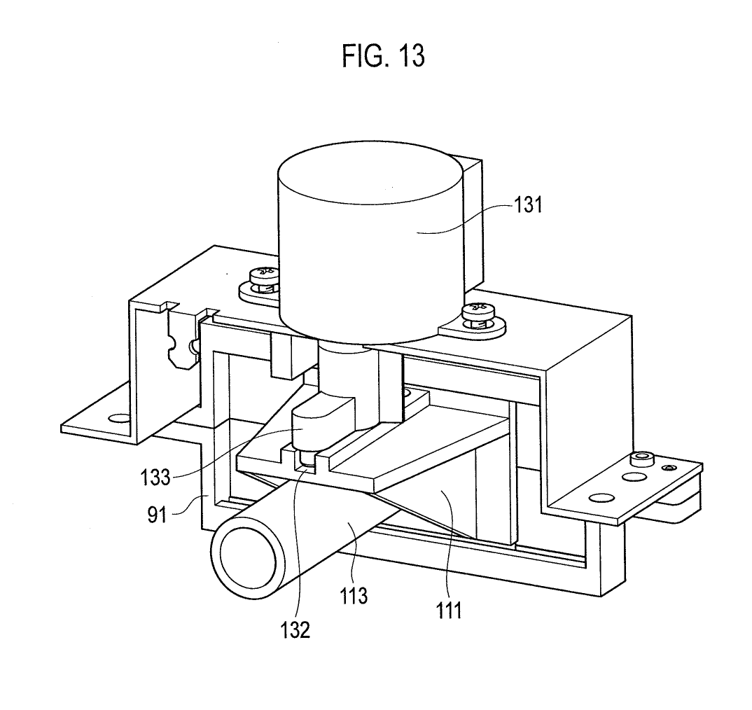

As shown in FIG. 13, the selection section 81 includes a sliding nozzle drive motor 131. The sliding nozzle drive motor 131 is composed of a stepping motor, and drive thereof is controlled under control of a jetting control unit 176 to be described later.

The sliding nozzle 111 is coupled to an eccentric output shaft 133 of the sliding nozzle drive motor 131 while interposing a cam groove 132, which is provided on the sliding nozzle 111, therebetween.

The eccentric output shaft 133 of the sliding nozzle drive motor 131 performs a reciprocating motion along the cam groove 132 by rotation of the eccentric output shaft 133. In such a way, the sliding nozzle 111 reciprocally moves in the direction previously shown by the arrow of FIG. 11.

By this reciprocating motion, the selection section 81 positionally aligns the shock wave jetting port 121 of the sliding nozzle 111 and the fixed nozzle jetting port 92 with each other so that the center axes of both thereof can approximately coincide with each other.

When the shock wave jetting port 121 of the sliding nozzle 111 and the fixed nozzle jetting port 92a are positionally aligned with each other, the shock wave guide tube 22a joined to the fixed nozzle jetting port 92a is selected. In such a way, the shock wave is transmitted to the jetting nozzle 21a through the shock wave guide tube 22a, and is jetted from the jetting nozzle 21a.

When the shock wave jetting port 121 of the sliding nozzle 111 and the fixed nozzle jetting port 92a are positionally aligned with each other, the shock wave guide tube 22b joined to the fixed nozzle jetting port 92b is selected. In such a way, the shock wave is transmitted to the jetting nozzle 21b through the shock wave guide tube 22b, and is jetted from the jetting nozzle 21b.

When the shock wave jetting port 121 of the sliding nozzle 111 and the fixed nozzle jetting port 92b are positionally aligned with each other, the shock wave guide tube 113 and the fixed nozzle jetting port 92b are arranged approximately linearly. In such a way, the attenuation of the shock wave, which is caused by such bending of the transmission passage, can be suppressed to the minimum.

When the shock wave jetting port 121 of the sliding nozzle 111 and the fixed nozzle jetting port 92c are positionally aligned with each other, the shock wave guide tube 22c joined to the fixed nozzle jetting port 92c is selected. In such a way, the shock wave is transmitted to the jetting nozzle 21c through the shock wave guide tube 22c, and is jetted from the jetting nozzle 21c.

In such a way as described above, the selection section 81 alternatively selects the jetting nozzles 21a, 21b and 21c which jet the shock waves.

Returning to FIG. 11, though not shown, the shock wave generation unit 114 is composed of: a piston with rack gears; a cylinder; a spring; an intermittent gear; a transmission gear group; an electric motor; and the like.

The shock wave generation unit 114 instantaneously slides the piston in the cylinder by release force of a compression spring, and thereby compresses the air in the cylinder steeply. The compressed air expands instantaneously from a cylinder port toward the shock wave jetting port 115, whereby the shock wave is generated, and is jetted from the shock wave jetting port 115. After the shock wave, the air that has expanded is jetted from the shock wave jetting port 115.

The shock wave generation unit 114 generates one shock wave by sliding the piston once. The shock wave generation unit 114 repeatedly slides the cylinder by the electric motor and the intermittent gear, and can thereby generate approximately ten shock waves per second. The shock wave generation unit 114 generates the shock waves under control of the jetting control unit 176 (shown in FIG. 17), which will be described later.

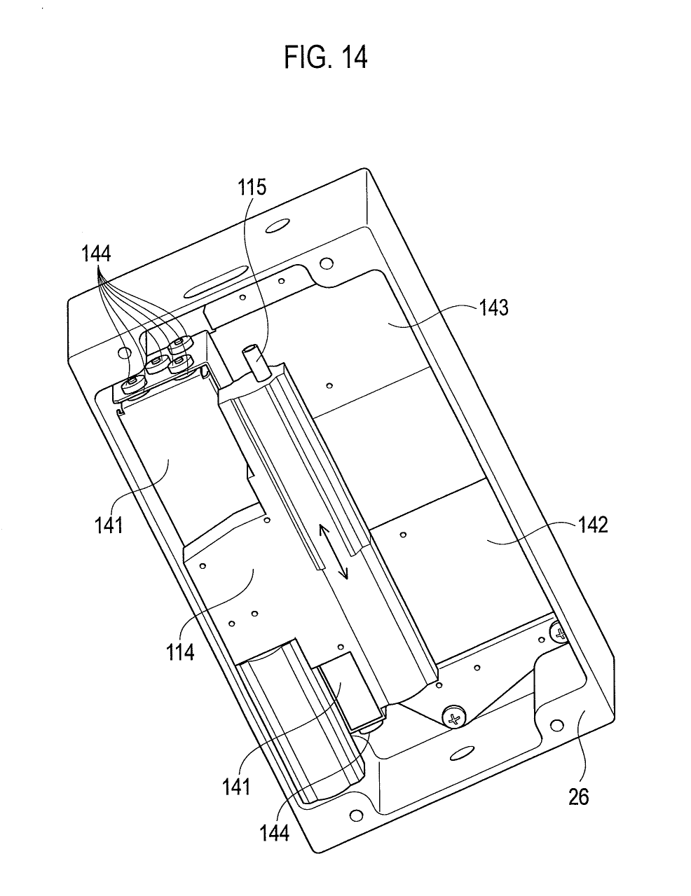

As shown in FIG. 14, the shock wave generation unit 114 is stored in the storage section 26 shown in FIG. 2. The shock wave generation unit 114 is fixed to a main bracket 141 by fixtures such as screws.

One end side of the main bracket 141 is attached to an attachment bracket 142 while interposing resin dampers 144 therebetween, and the other end side thereof is attached to an attachment bracket 143 while interposing such resin dampers 144 therebetween.

The attachment brackets 142 and 143 are fixed to the storage section 26 by fixtures such as screws. The shock wave generation unit 114 vibrates in an operating direction of the piston, which is shown by an arrow of FIG. 14, by inertia thereof at a time when the piston operates.

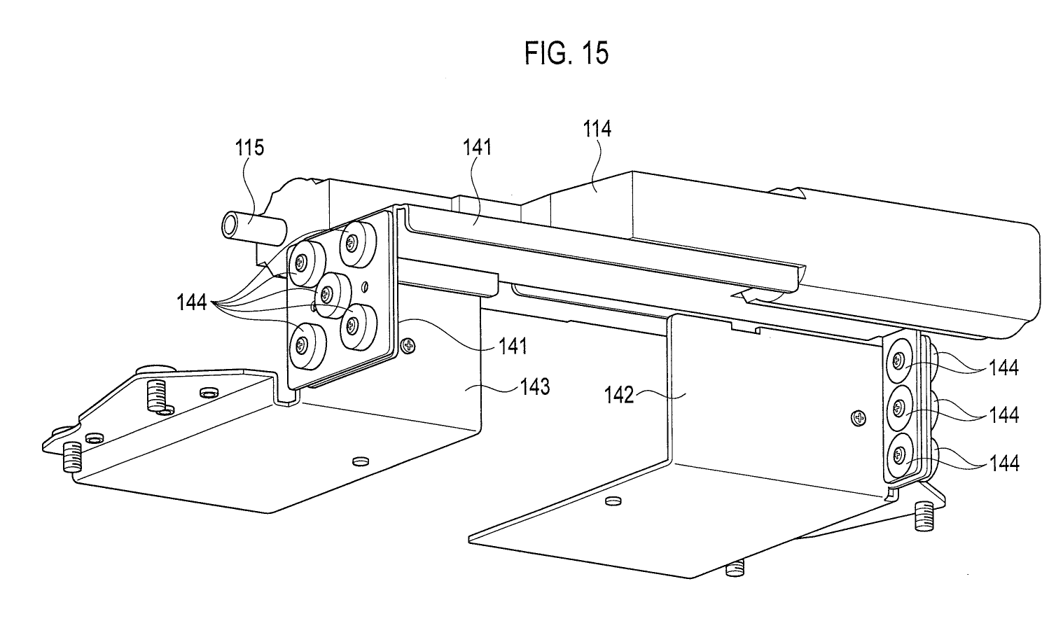

The resin dampers 144 set a main deformation direction thereof at the operating direction of the piston, which is shown by the arrow of FIG. 14, and are arranged on both ends of the main bracket 141 as shown in FIG. 15. With regard to the resin dampers 144, at least one or more thereof are arranged on each of both ends of the main bracket 141.

In FIG. 15, as an example, five resin dampers 144 are arranged on one end side of the main bracket 141, and three resin dampers 144 are arranged on the other end side. By the resin dampers 144, the vibrations generated in the shock wave generation unit 114 are absorbed and attenuated. In such a way, transmission of the vibrations, which are generated in the shock wave generation unit 114, to the storage section 26 can be reduced.

In the shock wave generation unit 114, an operating sound is generated at the time when the piston operates, and a plosive sound is generated at the time when the shock wave is generated. In order to reduce such sound pressures as described above, a sound absorbing material such as glass wool and a urethane foam material are provided in the storage section 26 according to needs.

Moreover, for example, silicone rubber for enhancing the hermetic sealing property for waterproof and soundproof purposes is interposed into a joint portion of a lid and box of the storage section 26.

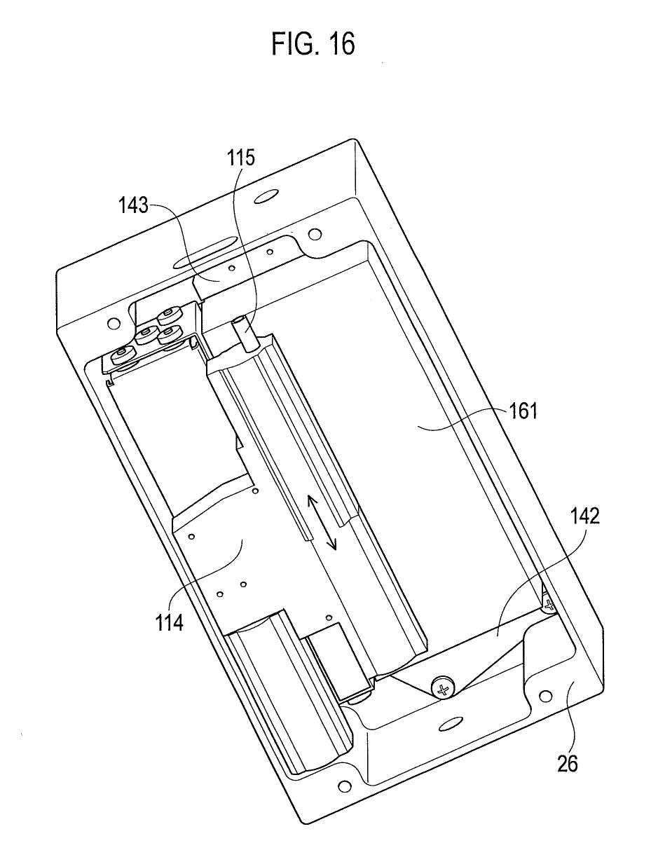

As shown in FIG. 16, in the storage section 26, a switching power supply unit 161 is housed under the circuit board 82 shown in FIG. 8. The switching power supply unit 161 receives an alternating current voltage from an outside source, and supplies a direct current voltage individually to the sliding nozzle drive motor 131, the electric motor of the shock wave generation unit 114 and the electronic circuit mounted on the circuit board 82.

The switching power supply unit 161 is fixed to the attachment brackets 142 and 143 by fixtures such as screws. In a similar way, the circuit board 82 shown in FIG. 8 is also fixed to the attachment brackets 142 and 143 by fixtures such as screws.

The switching power supply unit 161 generates heat at the time of the operation thereof, and accordingly, is arranged so that a heat sink provided on the switching power supply unit 161 can be opposed to an inner wall surface of the storage section 26. A thermal conduction sheet (not shown) is arranged between the heat sink of the switching power supply unit 161 and the inner wall surface of the storage section 26.

In such a way, the heat generated in the switching power supply unit 161 travels to the storage section 26 efficiently, and a heat radiation effect can be enhanced.

The shock wave generation unit 114 housed in the storage section 26 is configured so as to generate the shock waves as mentioned above, and accordingly, is capable of being made small and lightweight. The storage section 26 is configurable so that a total weight of the storage section itself and such materials for the storage section can be approximately 3.5 kg or less and that a volume thereof can be 0.0035 m³ or less.

In such a way, in an event of attaching the water droplet removal apparatus to the surveillance camera apparatus 11, it is made possible for a builder to carry the storage section 26 by a single hand.

As a result, workability in an event of attaching the water droplet removal apparatus later to the surveillance camera apparatus 11 placed at an outdoor high place or the like can be enhanced.

FIG. 17 is a diagram showing a configuration for controlling the camera 12, the selection section 81 and the shock wave generation unit 114.

The camera 12 is supported inside of the cabinet section 13, which is shown in FIG. 1, by being suspended by the support drive unit 171. The camera 12 is housed in the inside of the cabinet section 13 so as to be rotatable by the support drive unit 171 under control of the camera control unit 172.

The support drive unit 171 includes a pan motor 173 and a tilt motor 174. With regard to the support drive unit 171, a horizontal rotational operation thereof is controlled by the drive control of the pan motor 173. With regard to the support drive unit 171, a vertical rotational operation thereof is controlled by the drive control of the tilt motor 174.

The camera 12 includes a zoom motor 175 that performs a zoom operation of changing a magnification of an imaging lens. The pan motor 173 and the tilt motor 174 are composed of direct drive motors, and the zoom motor 175 is composed of a stepping motor.

With regard to each of these motors, rotation thereof is controlled by a pulse count value of a pulse signal, and a rotation amount thereof is proportional to the pulse count value. In such a way, it becomes possible to detect, based on the pulse count value, a movement position of a movable body of which movement is controlled by the rotation of the direct drive motor or the stepping motor.

Hence, the support drive unit 171, which is moved by being driven by the direct driver motor, and the sliding nozzle 111, which is moved by being driven by the stepping motor mentioned above, become capable of recognizing and controlling the movement position based on the pulse count value of the pulse signal that controls the drive of each of the motors.

With regard to the camera 12, a pan rotational operation thereof, in which the camera 12 concerned rotates in a pan direction as the horizontal direction, is controlled in such a manner that the drive of the pan motor 173 of the support drive unit 171 is controlled. With regard to the camera 12, a tilt rotational operation thereof, in which the camera 12 concerned rotates in a tilt direction as the vertical direction, is controlled in such a manner that the drive of the tilt motor 174 of the support drive unit 171 is controlled.

The camera 12 is also called a PTZ camera in such a manner that control directions of the imaging are represented by PTZ. P of the PTZ is an abbreviation of pan, that is, Panoramic View, and represents the rotation in the horizontal direction, and T of the PTZ is an abbreviation of tilt, and represents a swing in the vertical direction. Z of the PTZ is an abbreviation of zoom, and represents that the subject is to be imaged while being magnified (zoomed in) or reduced (zoomed out).

With regard to the camera 12, imaging directions thereof are determined under control of the camera control unit 172 in such a manner that the support drive unit 171 is rotated. Under control of the camera control unit 172, the camera 12 sequentially performs the imaging while changing a plurality of the preset imaging directions in a preset cycle.

The camera control unit 172 functions as a control center that controls operations of the entire surveillance camera apparatus 11. The camera control unit 172 has a memory unit that memorizes a control program for controlling the whole of the surveillance camera apparatus 11, and controls the operations of the whole of the surveillance camera apparatus 11 based on the control program memorized in the memory unit.

The camera control unit 172 is composed, for example, of a microcomputer equipped with resources such as a CPU, a memory apparatus, an input/output apparatus and the like.

The camera control unit 172 gives the pan motor 173 a drive control pulse signal of the pulse count value, and controls a rotation operation of the pan motor 173 based on this drive control pulse signal.

That is to say, the drive of the pan motor 173 is controlled based on the pulse count value, and with regard to the support drive unit 171, a rotation operation thereof in the pan direction is controlled by the pan motor 173 of which drive is controlled based on the pulse count value.

In such a way, the camera control unit 172 detects the imaging direction of the camera 12 in the pan direction by the pulse count value of the drive control pulse signal given to the pan motor 173. The camera control unit 172 gives the jetting control unit 176 the detected imaging direction of the camera 12 in the pan direction.

The jetting control unit 176 functions as a control center that controls operations of the selection section 81 and the shock wave generation unit 114. The jetting control unit 176 has a memory unit that memorizes a control program for controlling the operations of the selection section 81 and the shock wave generation unit 114, and controls the operations of the selection section 81 and the shock wave generation unit 114 based on the control program memorized in the memory unit.

The jetting control unit 176 is composed, for example, of a microcomputer equipped with resources such as a CPU, a memory device, an input/output device and the like.

The jetting control unit 176 gives the sliding nozzle drive motor 131 the drive control pulse signal of the pulse count value, and controls drive of the sliding nozzle drive motor 131 based on this drive control pulse signal.

That is to say, with regard to the sliding nozzle 111, a reciprocating motion thereof is controlled by the sliding nozzle drive motor 131 of which drive is controlled based on the pulse count value.

Based on the pulse count value of the drive control pulse signal, the jetting control unit 176 detects a position of the sliding nozzle 111 of which movement is controlled by the sliding nozzle drive motor 131.

As mentioned above, the jetting control unit 176 performs the positional alignment between the shock wave jetting port 121 of the sliding nozzle 111 and the fixed nozzle jetting ports 92a, 92b and 92c of the fixed nozzle 91, and controls the above-mentioned selection operation of the selection section 81.

After the selection operation by the selection section 81 is performed, the jetting control unit 176 generates the shock waves a predetermined number of times, which is preset by the shock wave generation unit 114.

The generated shock waves are transmitted to the jetting nozzles 21 through the sliding nozzle 111, the fixed nozzle jetting ports 92 of the fixed nozzle 91 coupled to the sliding nozzle 111, and the shock wave guide tubes 22, and are then jetted from the jetting nozzles 21 to the surface of the dome cover 15.

For the three jetting nozzles 21a, 21b and 21c, the jetting control unit 176 selects and executes, for example, three jetting patterns 1 to 3, which are for jetting the shock waves, based on the imaging directions in the pan direction of the camera 12, which are given from the camera control unit 172.

Note that the jetting patterns are not limited to these three patterns, and can be variously set by a surveillant who uses the surveillance camera apparatus 11.

In this event of making the description of the three jetting patterns 1 to 3, it is assumed that the jetting nozzles 21a, 21b and 21c are arranged, for example, as shown in FIG. 18. FIG. 18 is a view showing an arrangement example of the jetting nozzles 21a, 21b and 21c with respect to the dome cover 15.

In FIG. 18, with respect to the center O of a circular opening surface that forms such a hemispherical bottom surface of the dome cover 15, the frontal direction opposed to the wall 18 is defined to be 0°, and a direction of the wall 18 is defined to be 180°. In such an orientation as described above, the jetting nozzle 21a is arranged at a position of 270° with respect to the dome cover 15, the jetting nozzle 21b is located at a position of 0°, and the jetting nozzle 21c is located at a position of 90°.

In FIG. 18, it is assumed that the jetting nozzle 21a jets the shock wave in a range of 225° to 315° while taking 270° of the arrangement position thereof as a center. It is assumed that the jetting nozzle 21b jets the shock wave in a range of 315° to 45° while taking 0° of the arrangement position thereof as a center. It is assumed that the jetting nozzle 21c jets the shock wave in a range of 45° to 180° while taking 90° of the arrangement position thereof as a center.

In such an arrangement of the jetting nozzles 21a, 21b and 21c as described above, in the jetting pattern 1, the shock waves are jetted while changing the jetting nozzles 21a, 21b and 21c in a preset predetermined cycle. For example, the shock waves are jetted from the jetting nozzles 21 repeatedly in order of the jetting nozzle 21a, the jetting nozzle 21b, the jetting nozzle 21c and the jetting nozzle 21a.

In such a way, irrespective of the imaging direction in the pan direction of the camera 12, the shock waves can be jetted to the dome cover 15 in the imaging range of the camera 12 except a range of 135° to 225° in the dome cover 15, the range being located on the wall 18 side.

In the jetting pattern 2, based on the imaging direction in the pan direction of the camera 12, the imaging direction being given from the camera control unit 172, the shock wave is jetted from the jetting nozzle 21 corresponding to the imaging direction in the pan direction where the camera 12 is performing the imaging at the time of imaging.

In a case where the imaging direction in the pan direction of the camera 12 is in the range of 225° to 315° of FIG. 18, the shock wave is jetted from the jetting nozzle 21a. That is to say, the shock wave jetting port 121 of the sliding nozzle 111 and the fixed nozzle jetting port 92a of the fixed nozzle 91 are positionally aligned with each other by the selection section 81, and the shock wave is transmitted from the jetting nozzle 21a through the shock wave guide tube 22a, and is jetted from the jetting nozzle 21a.

In a case where the imaging direction in the pan direction of the camera 12 is in the range of 315° to 45° of FIG. 18, the shock wave is jetted from the jetting nozzle 21b.

That is to say, the shock wave jetting port 121 of the sliding nozzle 111 and the fixed nozzle jetting port 92b of the fixed nozzle 91 are positionally aligned with each other by the selection section 81, and the shock wave is transmitted from the jetting nozzle 21b through the shock wave guide tube 22b, and is jetted from the jetting nozzle 21b.

In a case where the imaging direction in the pan direction of the camera 12 is in the range of 45° to 135° of FIG. 18, the shock wave is jetted from the jetting nozzle 21c.

That is to say, the shock wave jetting port 121 of the sliding nozzle 111 and the fixed nozzle jetting port 92c of the fixed nozzle 91 are positionally aligned with each other by the selection section 81, and the shock wave is transmitted from the jetting nozzle 21c through the shock wave guide tube 22c, and is jetted from the jetting nozzle 21c.

As described above, in the jetting pattern 2, the shock wave can be jetted to the dome cover 15 in the imaging direction where the camera 12 is performing the imaging at present.

In the jetting pattern 3, the shock wave is jetted to the dome cover 15 in the imaging direction before the camera performs the imaging. Plural pieces of such imaging directions in the pan direction where the camera 12 performs the imaging are preset in the camera control unit 172. The camera 12 sequentially performs the imaging while periodically changing the preset plural imaging directions.

It is assumed that, for example, an imaging direction 1, an imaging direction 2 and an imaging direction 3 are preset in the camera 12, and the camera 12 repeatedly performs the imaging while periodically changing these imaging directions in this order. Here, it is assumed that the imaging direction 1 is, for example, a direction of 60° in FIG. 18, that the imaging direction 2 is, for example, a direction of 340° therein, and that the imaging direction 3 is, for example, a direction of 250°.

In such a case, in the jetting pattern 3, the imaging direction 1 belongs to a jetting range where the jetting nozzle 21c jets the shock wave, and accordingly, the shock wave is jetted from the jetting nozzle 21c in advance before the camera 12 performs pan rotation and imaging in the imaging direction 1.

Subsequently, the imaging direction 2 belongs to a jetting range where the jetting nozzle 21b jets the shock wave, and accordingly, the shock wave is jetted from the jetting nozzle 21b in advance before the camera 12 performs the pan rotation and imaging in the imaging direction 2.

Far more subsequently, the imaging direction 3 belongs to a jetting range where the jetting nozzle 21a jets the shock wave, and accordingly, the shock wave is jetted from the jetting nozzle 21a in advance before the camera 12 performs the pan rotation and imaging in the imaging direction 3.

As described above, in the jetting pattern 3, before the camera 12 performs the imaging, the shock wave is jetted to the dome cover 15 in the imaging direction where the camera 12 performs the imaging, and thereby removes or micronizes the water droplet. In such a way, the camera 12 can perform the imaging through the dome cover 15 from which the water droplet is previously removed or on which the water droplet is previously micronized.

Returning to FIG. 17, the camera control unit 172 is connected to a surveillance apparatus 177.

The surveillance apparatus 177 is connected to the camera control unit 172, for example, by a LAN, and performs transmission/reception of a signal with the camera control unit 172, for example, by using protocol such as TCP/IP.

The surveillance apparatus 177 receives image data of a captured image acquired by the camera 12, and performs control to display the captured image, which is acquired by the camera 12, on a display. The surveillance apparatus 177 memorizes the image data, which is acquired by the camera 12, in the memory device according to needs.

In a case where the camera 12 images the subject based on an instruction from the surveillance apparatus 177, the surveillance apparatus 177 adjusts and controls imaging conditions such as a diaphragm and the imaging direction in the event where the camera 12 performs the imaging, and gives these imaging conditions to the camera control unit 172.

The surveillance apparatus 177 manually or automatically instructs ON/OFF of the water droplet removal apparatus. For example, based on the captured image acquired by the camera 12, the surveillance apparatus 177 can instruct the ON/OFF of the water droplet removal apparatus, for example, automatically in the following manner.

When it is detected that the water droplet is adhered to the dome cover 15 and that the captured image becomes unclear by a predetermined image processing method, which is prepared in advance and detects sharpness of the image, the surveillance apparatus 177 activates the water droplet removal apparatus. Thereafter, when it is detected that the captured image has become clear, the surveillance apparatus 177 stops the water droplet removal apparatus.

As described above, in accordance with Embodiment 1, the water droplet adhered to the dome cover 15 is removed or micronized by the shock wave, and accordingly, sharpening of the captured image, which is acquired in such a manner that the camera 12 images the subject through the dome cover 15, can be achieved.

The water droplet is removed or micronized by the shock wave, and accordingly, the water droplet can be removed or micronized in a non-contact state with the dome cover 15. In such a way, in comparison with the case of removing the water droplet by the wiper that directly contacts the imaging window, effects as shown below can be obtained.

In the case of using the wiper, there is a possibility that the wiper may be projected onto the captured image and may obstruct part thereof. Therefore, there is a possibility that it may become difficult to view the captured image. Moreover, in a case where the imaging window is formed of resin such as acrylic resin, there is a possibility that the surface of the imaging window may be damaged by the wiper.

Moreover, in a case where the wiper is made of rubber, it has been necessary to maintain and manage the wiper by periodic exchange thereof or the like owing to deterioration from ultraviolet rays, waste powder from abrasion, accumulation of dust, or the like.

On the contrary, since the shock wave is used in Embodiment 1, the projection of the wiper onto the captured image, which results in the obstruction to a part of the captured image, is avoided, and damage to the imaging window by the wiper is avoided. Moreover, it becomes unnecessary to perform such maintenance and management of periodically exchanging the wiper, and time and labor for the maintenance and the management can be reduced.

Furthermore, in Embodiment 1, in comparison with the case where the hydrophilic or water-repellent coating is implemented for the imaging window, there can be solved such a malfunction that dirt remains on the imaging window after the water droplet adhered to the imaging window is dried. With regard to the hydrophilic or water-repellent coating implemented for the imaging window, an effect thereof is decreased owing to a chronological change, and accordingly, periodic maintenance and management are necessary.

In Embodiment 1, the maintenance and the management, which are as described above, are unnecessary, and the time and the labor for the maintenance and the management can be reduced.

In Embodiment 1, the shock wave generation unit 114 is composed by including: the cylinder that compresses the air by instantaneously sliding the piston and instantaneously expanding the compressed air from the cylinder port; and the compression spring that instantaneously slides the piston by the release force of the spring.

By this configuration, the shock wave generation unit 114 can generate the shock waves without using a configuration, which includes a compressor, an air cylinder and the like and holds a high pressure state. In such a way, it becomes possible to make the shock wave generation unit 114 small and lightweight, and as a result of this, the water droplet removal apparatus can be made small and lightweight.

In Embodiment 1, the jetting of the shock waves is controlled by the three jetting patterns 1 to 3. In the jetting pattern 1, the shock waves are jetted while changing the jetting nozzles 21a, 21b and 21c in the predetermined cycle. In such a way, irrespective of the imaging direction in the pan direction of the camera 12, the shock waves can be jetted to the dome cover 15 in the imaging range of the camera 12.

In the jetting pattern 2, the shock wave is jetted from the jetting nozzle 21 corresponding to the imaging direction in the pan direction where the camera 12 is performing the imaging at present. In such a way, the shock wave can be jetted to the dome cover 15 in the imaging direction where the camera 12 is performing the imaging at present.

In the jetting pattern 3, the shock wave is jetted to the dome cover 15 in the preset imaging direction before the camera 12 performs the imaging. In such a way, the camera 12 can perform the imaging through the dome cover 15 from which the water droplet is previously removed or on which the water droplet is previously micronized.

Note that, in Embodiment 1, the description is made on the assumption that the imaging window is the approximately hemispherical dome cover; however, the imaging window is not limited to the approximately hemispherical dome cover, and for example, the imaging window may be planar. The present invention does not restrict the shape of the imaging window.

### Embodiment 2

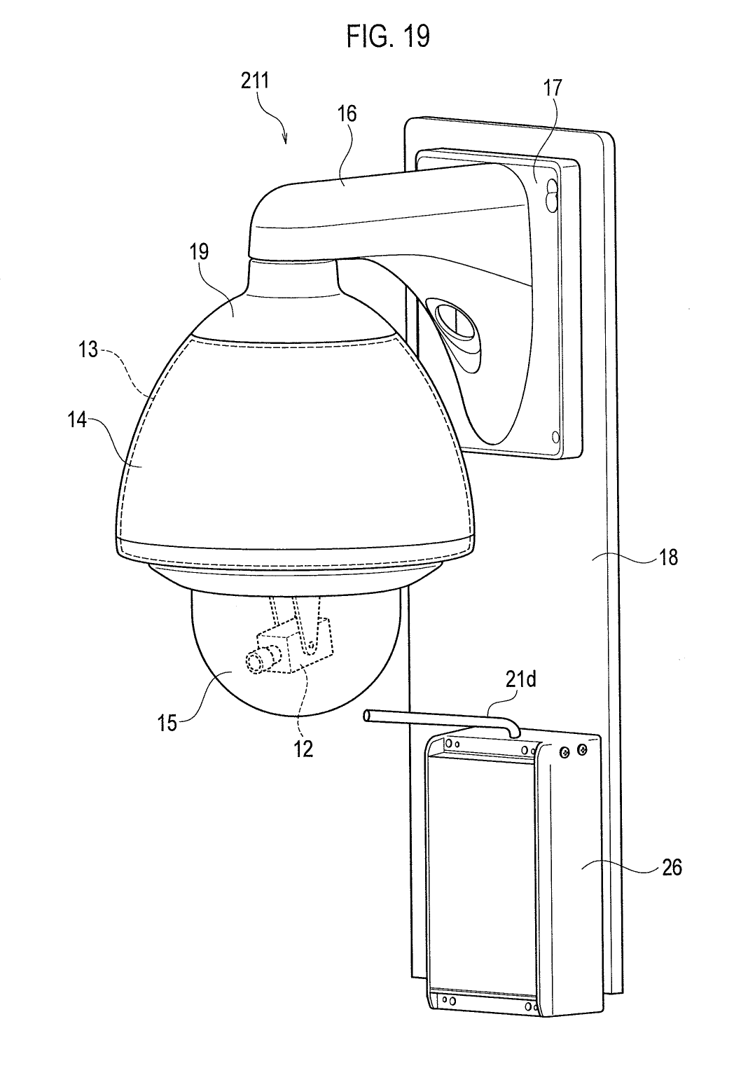

FIG. 19 is a perspective view showing an exterior appearance of a surveillance camera apparatus 211 including a water droplet removal apparatus according to Embodiment 2.

The surveillance camera apparatus 211 has a similar configuration to that of the surveillance camera 11 of Embodiment 1. In Embodiment 2, a configuration of the water droplet removal apparatus and an attaching configuration thereof are different from those of Embodiment 1. Hereinafter, the same reference numerals are assigned to similar components to those of Embodiment 1, and a description thereof is sometimes omitted.

The water droplet removal apparatus is attached to the vicinity of the surveillance camera apparatus 211, and removes a water droplet, which is built up in the vicinity of a vertex of the hemispherical shape of the dome cover 15, by the shock wave.

The water droplet removal apparatus includes a jetting nozzle 21d. The water droplet removal apparatus is placed, for example, on a wall in the vicinity of the surveillance camera apparatus 211 so that the jetting nozzle 21d can be located at a position from which the jetting nozzle 21d jets the shock wave toward the vicinity of the hemispherical shape of the dome cover 15.

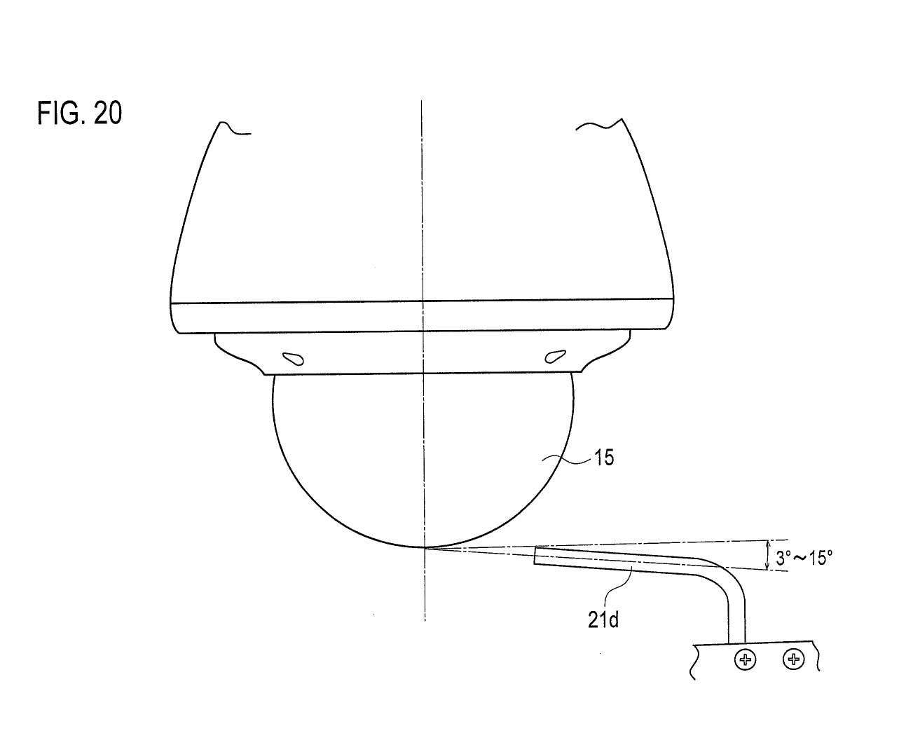

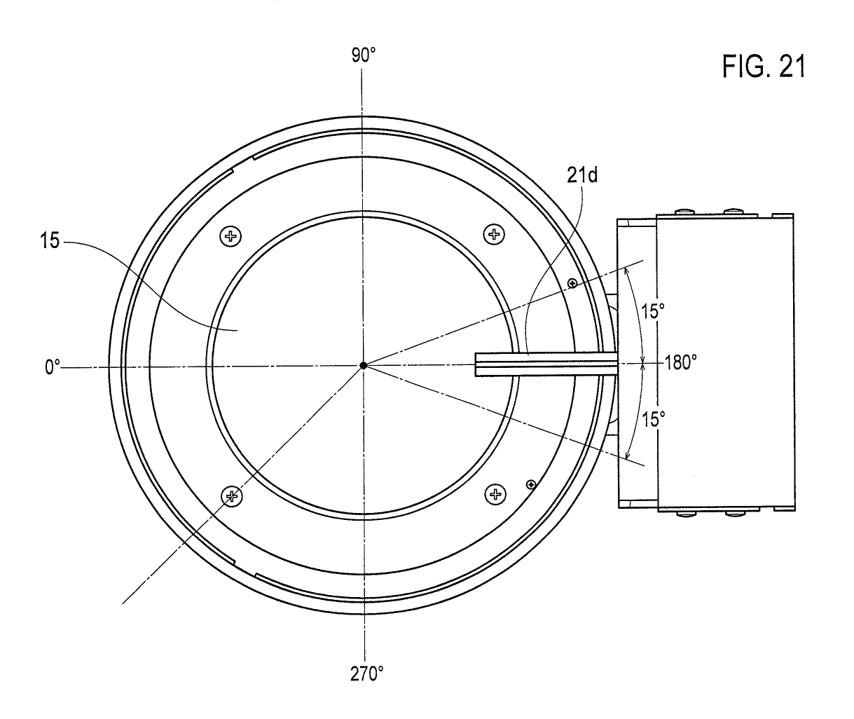

FIG. 20 and FIG. 21 show a positional relationship between the jetting nozzle 21d and the dome cover 15.

As shown in FIG. 20, a tip end of the jetting nozzle 21d is directed toward the vertex of the hemispherical shape of the dome cover 15, and desirably, an angle of this placement is set in a range of 3° to 15° with respect to the horizontal direction of the surveillance camera.

Moreover, as shown in FIG. 21, in the case where the frontal direction of the dome camera is 0°, desirably, position of the jetting nozzle 21d on the horizontal plane is set in a range of 180°±15°. By placing the jetting nozzle 21d in the above-described range, the water droplet, which is built up in the vicinity of the vertex of the hemispherical shape of the dome cover 15, can be blown away effectively by the shock wave.

The shock waves are jetted from the jetting nozzle 21d approximately ten times per second, and this jetting is performed for a few seconds, whereby the water droplet is blown away and removed.

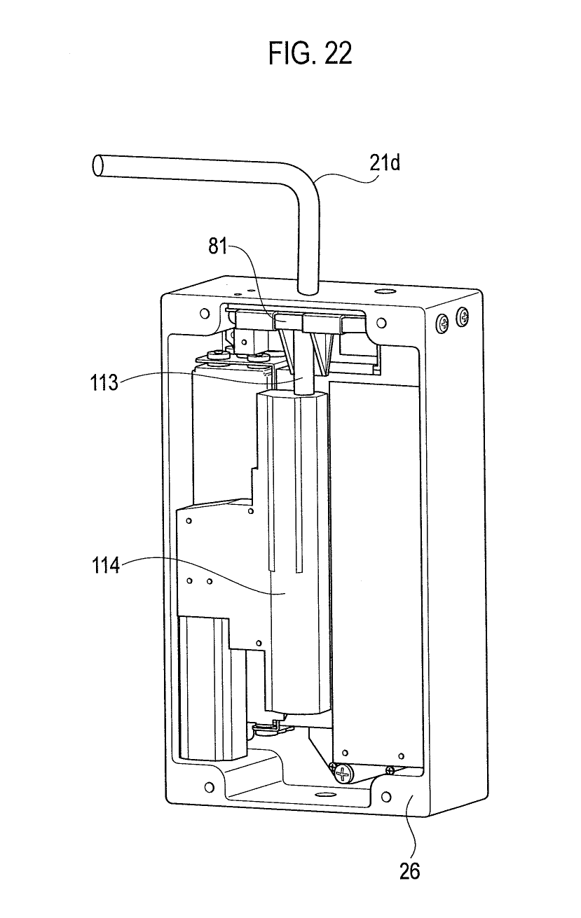

FIG. 22 shows a configuration of the shock wave generation unit. The configuration of the shock wave generation unit is basically similar to that in Embodiment 1; however, the number of jetting nozzles in Embodiment 2 just needs to be one, which is the jetting nozzle 21d, and accordingly, the selection section 81 is unnecessary. Such a configuration just needs to be adopted, in which the jetting nozzle 21d is directly coupled to the shock wave generation unit 114 while interposing one transmission tube 113 therebetween.

In a similar way to Embodiment 1, such a configuration is adopted, in which the operation of the water droplet removal apparatus is remotely performed from the surveillance apparatus 177. The surveillant can also activate the water droplet removal apparatus manually while confirming the built-up state of the water droplet in the vicinity of the vertex of the hemispherical shape of the dome cover 15 by the captured image.

Moreover, such a configuration may be adopted, in which the fact that the water droplet is built up in the vicinity of the vertex of the dome cover 15 and that the captured image becomes unclear is automatically sensed by image processing software, and the water droplet removal apparatus is activated.

A raindrop which is adhered to the surface of the dome cover 15 becomes a water droplet. The water droplet thus adhered becomes large by being bonded to another scattered raindrop and water droplets on the periphery thereof, and before long, flows downward, that is, toward the vertex of the dome cover 15 by self-weight thereof.

The water droplet, which has reached the vicinity of the vertex of the dome cover 15, leaves the dome cover 15, and falls therefrom; however, is partially built up in the vicinity of the dome cover 15 in a state of the water droplet. When the water droplet is dried after a time elapses in that state, then dust, dirt, salt and the like, which are contained in the water droplet, are precipitated, becoming dirt and deposition, and damage the transparency in the vicinity of the vertex of the dome cover 15. As a result, the captured image in the vicinity of the vertex of the dome cover becomes unclear.

In accordance with Embodiment 2, the water droplet adhered to the vicinity of the vertex of the hemispherical shape of the dome cover 15 is removed or micronized by the shock wave, and accordingly, the sharpening of the captured image, which is acquired in such a manner that the camera 12 images the subject through the dome cover 15, can be achieved.

The water droplet is removed or micronized by the shock wave, and accordingly, the water droplet can be removed or micronized in a non-contact state with the dome cover 15. In such a way, in comparison with the case of removing the water droplet by the wiper that directly contacts the imaging window, such effects as shown below can be obtained.

In the case of using the wiper, there is a possibility that the wiper may be projected onto the captured image and may obstruct a part of the sight. Therefore, there is a possibility that it may become difficult to watch the captured image. Moreover, in the case where the imaging window is formed of the resin such as the acrylic resin, there is a possibility that the surface of the imaging window may be damaged by the wiper. Moreover, in the case where the wiper is made of rubber, it has been necessary to maintain and manage the wiper by the periodic exchange thereof or the like owing to the deterioration by the ultraviolet rays, the waste powder by abrasion, the accumulation of dust, or the like.

As opposed to this, since the shock wave is used in Embodiment 2, the projection of the wiper onto the captured image, which results in the obstruction to a part of the captured image, is avoided, and damage to the imaging window by the wiper is avoided. Moreover, it becomes unnecessary to perform the maintenance and management of periodically exchanging the wiper, and the time and the labor for the maintenance and the management can be reduced.

Furthermore, in Embodiment 2, in comparison with the case where the hydrophilic or water-repellent coating is implemented for the imaging window, there can be solved such a malfunction that the dirt remains on the imaging window after the water droplet adhered to the imaging window is dried. With regard to the hydrophilic or water-repellent coating implemented for the imaging window, the effect thereof is decreased owing to a chronological change, and accordingly, periodic maintenance and management are necessary.

As opposed to this, in Embodiment 2, the maintenance and the management, which are as described above, are unnecessary, and the time and the labor for the maintenance and the management can be reduced.

In Embodiment 2, the shock wave generation unit 114 is composed by including: the cylinder that compresses the air by instantaneously sliding the piston and instantaneously expanding the compressed air from the cylinder port; and the compression spring that instantaneously slides the piston by the release force of the spring.

By this configuration, the shock wave generation unit 114 can generate the shock waves without using such a configuration, which includes a compressor, an air cylinder and the like and holds a high pressure state. In such a way, it becomes possible to make the shock wave generation unit 114 small and lightweight, and as a result of this, the water droplet removal apparatus can be made small and lightweight.

Note that, in Embodiment 2, the description is made on the assumption that the imaging window is the approximately hemispherical dome cover; however, the imaging window is not limited to the approximately hemispherical dome cover, and for example, the imaging window may be planar. The present invention does not restrict the shape of the imaging window.

As a matter of course, a configuration obtained by combining Embodiment 1 and Embodiment 2 with each other may be adopted. In this case, such a configuration just needs to be adopted in which the jetting nozzle 21 connected to the tip of one of the plurality of shock wave guide tubes 22 connected to the selection section 81 is arranged as described in Embodiment 2, and the jetting nozzles 21 connected to the rest of the shock wave guide tubes 22 are arranged as described in Embodiment 1.

By adopting the configuration obtained by combining Embodiment 1 and Embodiment 2, the effects of both of Embodiment 1 and Embodiment 2, which are described therein, can be obtained.

What is claimed is:

1. A water droplet removal apparatus comprising:
a jetting nozzle configured to jet a shock wave onto an imaging window of a camera;
an arrangement section that arranges the jetting nozzle on a periphery of the imaging window;
a shock wave generation unit configured to generate the shock wave jetted from the jetting nozzle; and
a jetting control unit configured to control jetting of the shock wave jetted from the jetting nozzle.

2. The water droplet removal apparatus according to claim 1, wherein the arrangement section is freely detachably attached to the camera.

3. The water droplet removal apparatus according to claim 1, wherein
the jetting nozzle is a plurality of jetting nozzles,
the arrangement section arranges the plurality of jetting nozzles on a periphery of the imaging window so that the plurality of jetting nozzles can jet the shock waves onto the imaging window in directions different from one another,
the shock wave generation unit is configured to generate the shock waves jetted from the plurality of jetting nozzles, and
the jetting control unit is configured to perform control to select the jetting nozzle from the plurality of jetting nozzles, and to jet the shock wave from the selected jetting nozzle.

4. The water droplet removal apparatus according to claim 3, wherein the jetting control unit is configured to perform control to select the jetting nozzle that jets the shock wave onto the imaging window based on an imaging direction of the camera in a horizontal direction and on arrangement positions of the plurality of jetting nozzles, and to jet the shock wave from the selected jetting nozzle.

5. The water droplet removal apparatus according to claim 3, wherein
the camera is configured to sequentially perform imaging while periodically changing a plurality of the preset imaging directions,
the water droplet removal apparatus is mounted on a camera apparatus including the camera, and
the jetting control unit is configured to perform, before the camera images a subject in a preset imaging direction, control to select the jetting nozzle that jets the shock wave onto the imaging window based on the preset imaging direction where the camera performs the imaging and on arrangement positions of the plurality of jetting nozzles, and to jet the shock wave from the selected jetting nozzle.

6. A camera apparatus comprising:
an imaging window;
a camera configured to image a subject through the imaging window;
a jetting nozzle arranged at a position from which a shock wave is jetted toward a portion where a water droplet adhered to the imaging window is built up, the jetting nozzle being configured to jet the shock wave onto the imaging window;
a shock wave generation unit configured to generate the shock wave jetted from the jetting nozzle; and
a jetting control unit configured to control the jetting of the shock wave jetted from the jetting nozzle.

7. The camera apparatus according to claim 6, wherein the imaging window has a hemispherical shape in which a vicinity of a vertex is directed downward, and the jetting nozzle is arranged at a position from which the shock wave is jetted onto the vicinity of the vertex of the hemispherical shape of the imaging window.
